(19) United States
(12) Patent Application Publication
(10) Pub. No.: US 2011/0074965 A1
(43) Pub. Date: Mar. 31, 2011

(54) VIDEO PROCESSING SYSTEM AND METHOD

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/610,360

(22) Filed: Nov. 2, 2009

(30) Foreign Application Priority Data
Sep. 30, 2009 (CN) 200910308017.2

(51) Int. Cl. H04N 5/225

(52) U.S. Cl. 348/218.1; 348/E05.024

(57) ABSTRACT

A video processing system includes a number of time-of-flight (TOF) cameras and a video card. The number of TOF cameras shoots different regions of a scene to obtain a number of images. The number of images includes distance data between the scene and the number of TOF cameras. The video card combines the number of images to obtain a full image of the scene. The full image of the scene has a larger size than that of each of the number of images, same resolution with that of each of the number of images, and distance data between the scene and the number of TOF cameras.

### BACKGROUND

1. Technical Field

The present disclosure relates to a video processing system and a video processing method.

2. Description of Related Art

Image resolution describes the detail an image holds. Higher resolution means more image detail. In digital camera field, a digital camera shoots a scene with maximum resolution, and an image the digital camera can obtain often has a fixed size. In that way, when users need an image with a larger size, the resolution of the image has to be reduced or the maximum resolution of the digital camera must be increased.

### BRIEF DESCRIPTION OF THE DRAWINGS

FIG. 1 is a schematic block diagram of an exemplary embodiment of a video processing system.

FIG. 2 is a schematic diagram of images captured by the video processing system in FIG. 1.

FIG. 3 is a flowchart of an embodiment of a video processing method.

### DETAILED DESCRIPTION

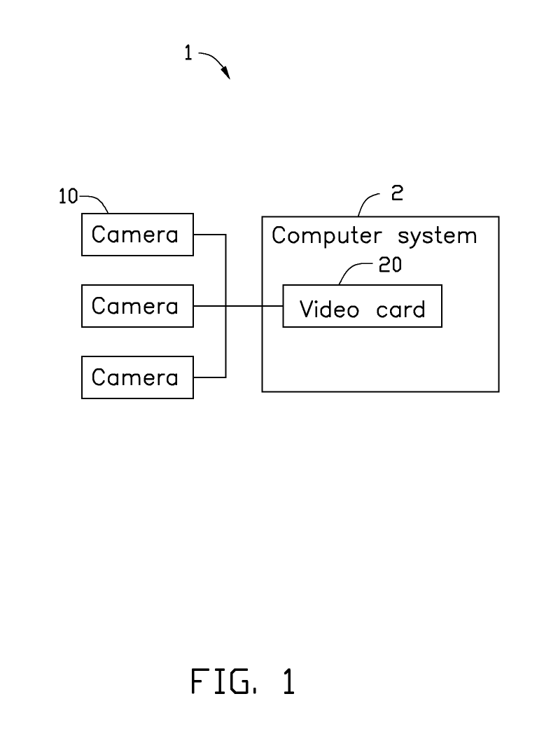

Referring to FIG. 1, an exemplary embodiment of a video processing system 1 includes a plurality of cameras 10 and a video card 20. The video processing system 1 is operable to shoot a scene to obtain an image. The image has high resolution and a large size.

Each camera 10 is a time-of-flight (TOF) camera. The TOF camera is a camera system that creates distance data between an object to be shoot and the TOF camera. The plurality of cameras 10 forms an array camera system. In the array camera system, the plurality of cameras 10 is arranged in circularity, or on a curved surface. The array camera system shoots the scene from multi-angles at a same time to obtain composite images.

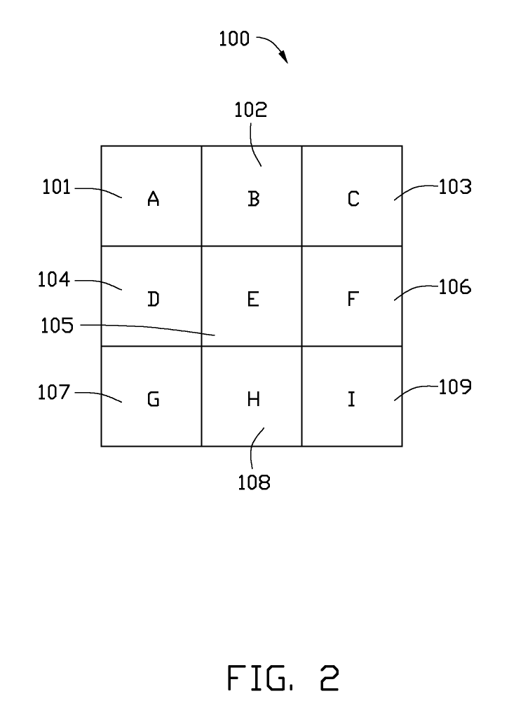

Referring to FIG. 2, the plurality of cameras 10 includes nine cameras 10. The nine cameras 10 shoot a first region A to a ninth region I of a scene 100, respectively. In another embodiment, the plurality of cameras 10 can include more or less cameras 10. The plurality of cameras 10 can be arranged in other shapes. When the video processing system 1 starts to work, the nine cameras 10 are turned on at the same time. The nine cameras 10 capture images of the nine regions A-I from different angles to obtain nine images 101-109 at the same time. The nine images 101-109 are transmitted to the video card 20.

The video card 20 may be installed in a computer system 2. When the nine images 101-109 are transmitted to the video card 20, the video card 20 combines the nine images 101-109 to obtain a full image of the scene 100. It can be understood that the video card 20 uses well known video processing technology to combine the nine images 101-109 to obtain the full image.

Suppose that each camera 10 shoots the scene 100 with maximum resolution of the camera 10, such as 1024 pixels×768 pixels, the maximum size of the image the camera 10 can obtain is 10 inches×10 inches with the maximum resolution of 1024 pixels×768 pixels. With the video processing system 1, because the full image is combined by the nine images 101-109, a size of the full image is 30 inches×30 inches. Resolution of the full image is equal to the maximum resolution of the camera 10. In other words, the resolution of the full image is 1024 pixels×768 pixels. By contraries, if users want to obtain an image with a size of 30 inches×30 inches using only one camera 10, the resolution of the image is lower than the image using the video processing system 1. In other words, the resolution of the image obtained by only one camera 10 is lower than 1024 pixels×768 pixels.

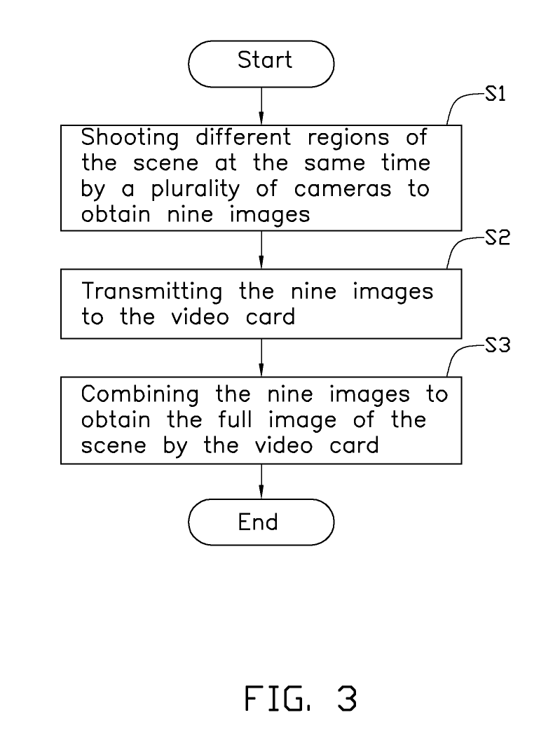

Referring to FIG. 3, an exemplary embodiment of a video processing method includes the following steps.

In step S1, the plurality of cameras 10 shoot different regions of the scene 100 at the same time to obtain nine images 101-109 corresponding to nine regions A-I of the scene 100. In the embodiment, each image includes distance data between the scene 100 and the camera 10.

In step S2, the nine images 101-109 corresponding to the different regions A-I of the scene 100 are transmitted to the video card 20.

In step S3, the video card 20 combines the nine images 101-109 to obtain the full image of the scene 100. The full image of the scene 100 includes distance data between the scene 100 and each camera 10. The full image of the scene 100 has a larger size, 30 inches×30 inches, than that of each of the plurality of images 101-109, and the same resolution, 1024 pixels×768 pixels, with that of each of the plurality of images 101-109.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A video processing system comprising:
a plurality of time-of-flight (TOF) cameras to shoot different regions of a scene to obtain a plurality of images, wherein the plurality of images comprises distance data between the scene and the plurality of TOF cameras; and
a video card to combine the plurality of images to obtain a full image of the scene, wherein the full image of the scene has a larger size than that of each of the plurality of images, same resolution with that of each of the plurality of images, and distance data between the scene and the plurality of TOF cameras.

2. The video processing system of claim 1, wherein the plurality of TOF cameras is arranged in circularity.

3. The video processing system of claim 1, wherein the plurality of TOF cameras is arranged on a curved surface.

4. The video processing system of claim 1, wherein the video card is installed in a computer system.

5. A video processing method comprising:
shooting different regions of a scene respectively by a plurality of time-of flight (TOF) cameras to obtain a plurality of images, wherein the plurality of images comprises distance data between the scene and the plurality of TOF cameras; and
combining the plurality of images by a video card to obtain a full image of the scene, wherein the full image has a larger size than that of each of the plurality of images, same resolution with that of each of the plurality of images, and distance data between the scene and the plurality of TOF cameras.

6. The video processing method of claim 5, wherein the plurality of TOF cameras is arranged in circularity.

7. The video processing method of claim 5, wherein the plurality of TOF cameras is arranged on a curved surface.

8. The video processing method of claim 5, wherein the video card is installed in a computer system.
